(19) United States
(12) Patent Application Publication
(10) Pub. No.: US 2019/0346845 A1
(43) Pub. Date: Nov. 14, 2019

(54) AUTONOMOUS CONTROL OF A MOTOR VEHICLE ON THE BASIS OF LANE DATA; MOTOR VEHICLE

(71) Applicant: AUDI AG, Ingolstadt (DE)

(72) Inventor: Lukas ROTTKAMP, Ingolstadt (DE)

(73) Assignee: AUDI AG, Ingolstadt (DE)

(21) Appl. No.: 16/349,245

(22) PCT Filed: Nov. 10, 2017
(86) PCT No.: PCT/EP2017/078914

§ 371 Date: May 10, 2019

(30) Foreign Application Priority Data
Nov. 18, 2016 (DE) 10 2016 222 782.3

(51) Int. Cl. G05D 1/00; G05D 1/02; G06K 9/00; B60W 30/12

(52) U.S. Cl. CPC G05D 1/0088; G05D 1/0212; G05D 2201/0213; B60W 30/12; G06K 9/00798

(57) ABSTRACT

The present disclosure relates to a method for autonomously guiding a motor vehicle. The method includes receiving a reference trajectory, by means of which a continuous sequence of steering maneuvers, acceleration maneuvers, or braking maneuvers is determined for a route to be traveled by the motor vehicle. The method also includes detecting data on the surroundings via a detection device of the motor vehicle, and checking the navigability of the reference trajectory on the basis of the data on the surroundings. The method further includes generating a driving trajectory by correcting the reference trajectory on the basis of the data on the surroundings, and guiding the motor vehicle autonomously along the driving trajectory via a control device of the motor vehicle. In order to enable a particularly anticipatory planning of the driving trajectory, the reference trajectory is used, which is configured independent of the data on the surroundings. The reference trajectory can be based on track data, through which a track course of a road is described, where the route to be traveled by the motor vehicle extends along the track course of the road.

### TECHNICAL FIELD

The disclosure relates to a method for the autonomous guidance of a motor vehicle, wherein a motor vehicle is autonomously controlled based on a trajectory along a route to be traveled.

### BACKGROUND

It is known from the prior art that motor vehicles can be moved autonomously.

For this purpose, for example, the surroundings of the motor vehicle are detected by at least one detection device, for example a Lidar sensor, a camera, in particular a mono camera or stereo camera, an ultrasound sensor or a radar sensor. Road markings as well as other road users, for example other motor vehicles, cyclists or pedestrians, as well as obstacles, can be detected. Based on such detected data on the surroundings, a trajectory for autonomous movement of the motor vehicle can be calculated. Due to a limited coverage or detection range of the detection device, a predictive planning of the trajectory is only possible to a limited extent.

### BRIEF DESCRIPTION OF THE DRAWINGS

FIG. 1 shows a schematic view of a motor vehicle and a central server device.

FIG. 2 shows an embodiment of the present method based on a schematic overview of a reference trajectory and a driving trajectory.

### DETAILED DESCRIPTION

It is an object of the present disclosure to enable a predictive planning of a trajectory for guiding a motor vehicle.

This object is achieved by way of the subject matters of the independent claims. Advantageous embodiments with expedient further developments are the subject of the subsidiary claims.

In the scope of the method according to the disclosure for the autonomous guidance of a motor vehicle, first of all a reference trajectory for a route to be traveled by the motor vehicle is received. The reference trajectory can be received by a receiving device of the motor vehicle. In particular, the reference trajectory is received from an in-vehicle arithmetic unit and/or from a vehicle-external arithmetic unit, for example a server device or a cloud. With the reference trajectory, a continuous trajectory or a continuous course of movement for a continuous sequence of driving maneuvers, in particular steering maneuvers and/or acceleration maneuvers and/or braking maneuvers, can be determined or predetermined. For example, the continuous sequence of driving maneuvers is calculated based on the reference trajectory. In particular, a movement of the motor vehicle can be clearly determined or predetermined by the reference trajectory. But this does not refer to the navigation information (e.g. “turn right at the next crossroads”). Accordingly, it may be possible to autonomously guide the motor vehicle solely based on the reference trajectory.

The reference trajectory can be a description of the, in particular preferred, course of movement. In particular, such a course of movement can be described by a sequence of positions, for example geographic coordinates (latitude and longitude) or positions of another coordinate system, together with speed values (at the positions). The driving maneuvers, in particular steering maneuvers, acceleration maneuvers and braking maneuvers, are, for example, only calculated in the motor vehicle.

However, this reference trajectory is preferably first checked. Data on the surroundings are collected from a detection device of the motor vehicle. Data on the surroundings relate to the surroundings of the motor vehicle. In particular, as part of the data on the surroundings, a position and/or a position of lane markings and/or dynamic vehicle-external objects, for example other motor vehicles and pedestrians, and/or stationary vehicle-external objects, such as lane boundaries, crash barriers and curbs, are detected. On the basis of the data on the surroundings, a navigability of the reference trajectory can be checked. In particular, it is checked whether a collision would take place if the reference trajectory was followed by the motor vehicle. For example, it is checked whether an object external to the vehicle is located on the reference trajectory or in a predefined region around the reference trajectory. Preferably, it is alternatively or additionally checked whether an object outside the vehicle is on a collision course with the motor vehicle if the latter follows the reference trajectory. Preferably, it is checked whether the motor vehicle leaves a lane when following the reference trajectory, for example by checking whether the motor vehicle passes over the lane markings. In general, the navigability can be identified when the reference trajectory and the data on the surroundings jointly satisfy a predetermined criterion. The predetermined criterion may, for example, be provided by one or more of the above-mentioned conditions.

By correcting the reference trajectory based on the data on the surroundings, a driving trajectory can be generated. If the reference trajectory does not satisfy the predetermined criterion, a driving trajectory is, in particular, generated which satisfies the predefined criterion. If, for example, an object external to the vehicle is located on the reference trajectory or in the predefined region around the reference trajectory, the reference trajectory can be corrected so that the driving trajectory passes by this vehicle-external object, in particular at a distance which is greater than a predefined distance limit value. Changes to the reference trajectory are, in particular, made by correcting the latter. Preferably, the reference trajectory is corrected only to the extent necessary to avoid a collision. For example, the course of movement predetermined by the reference trajectory is fitted to the surroundings of the motor vehicle in the event of a possible collision. The motor vehicle is guided autonomously along the driving trajectory. In particular, the motor vehicle is guided through a control unit of the motor vehicle. Since the driving trajectory preferably corresponds to the reference trajectory and, in particular, differs from the reference trajectory only in the case of non-navigability of the reference trajectory, the motor vehicle can therefore be guided substantially along the reference trajectory. The guiding comprises the longitudinal guidance and/or transverse guidance of the motor vehicle.

In order now to enable the predictive planning of a driving trajectory, it is provided according to the disclosure that a reference trajectory is used that is generated independently of the data on the surroundings on the basis of track data. The track data particularly describe a roadway or street course of a road along which the route runs. Track data may be a digital map that includes the location of lane markers and/or stationary objects outside the vehicle. The track data or the map can have a resolution or accuracy of more than 50 cm, 20 cm, 10 cm, 5 cm, 2 cm, 1 cm. In other words, the reference trajectory for guiding the motor vehicle can be calculated on the basis of the track data. The reference trajectory is preferably generated and/or calculated independently of the data on the surroundings on the basis of the track data, in particular by the arithmetic unit. The arithmetic unit may be an internal arithmetic unit of the motor vehicle or may be comprised by a vehicle-external server device. The reference trajectory can then be checked for navigability based on the data on the surroundings. The reference trajectory may be precalculated before being used directly to guide the motor vehicle. In general, it is thus possible to plan the trajectory in a particularly anticipatory manner on the basis of the track data.

In other words, the course of movement of the motor vehicle determined or predetermined by the reference trajectory can be different than that described by the reference trajectory. In particular, the course of movement predetermined by the reference trajectory can subsequently be modified on the basis of the data on the surroundings.

In a further embodiment of the disclosure, the route to be traveled, for which the reference trajectory is calculated, extends beyond a range of the detection device. In other words, the reference trajectory can be calculated at least partially for a region of the surroundings of the motor vehicle which is outside the range of the detection device. In this way, the predictive nature of the reference trajectory may extend beyond the detection device. In particular, it is already possible to react to upcoming occurrences on the route to be traveled. For example, it is possible to coast before entering localities or before tight curves, which dispenses with braking maneuvers and reduces the fuel consumption of the motor vehicle.

Preferably, the reference trajectory is calculated by a central server device and received by the motor vehicle. The central server device may comprise the arithmetic unit for calculating the reference trajectory. The reference trajectory is then sent from the central server device to the motor vehicle and/or detected by the motor vehicle, in particular by the receiving device. The server device may retrieve the track data from a storage unit and/or store it in the storage unit. The central server device can provide particularly great computing power in comparison of an in-vehicle arithmetic unit. In addition, the central server device can always have current track data or highly accurate maps at its disposal without transferring them to the motor vehicle. In particular, it is only the motor vehicle that receives the reference trajectory, whereby the amount of data to be received can be reduced to a minimum. In other words, in one embodiment, the central server device can exclusively send the reference trajectory to the motor vehicle.

In a further development of the disclosure, the reference trajectory is generated by simulating a journey along the road. For example, a comfort level can be simulated on the basis of forces acting on an occupant, and the reference trajectory can be generated on the basis of the result of the simulation. The comfort level can, in particular, be pre-selected by the occupant, whereby the occupant can, for example, choose a sporty or a comfortable ride. Lateral forces acting on the motor vehicle, in particular when driving through a curve, fuel consumption and/or any other variables can alternatively or additionally be simulated. The reference trajectory can then be fitted to the desired conditions based on the simulation by simulating different driving situations.

A further embodiment of the disclosure provides that the reference trajectory is calculated universally for several motor vehicles. In particular, different motor vehicles can be divided into vehicle categories and at least one reference trajectory is calculated for each vehicle category. Identical or similar motor vehicles are preferably classified in the same vehicle category. In particular, the motor vehicles are classified into the vehicle categories by the central server device. The central server device alternatively or additionally calculates the reference trajectory universally for multiple motor vehicles or for different vehicle categories. A respective reference trajectory can then be sent to one or more of the several motor vehicles. At least one corresponding reference trajectory can be received by each of the multiple motor vehicles. Universal reference trajectories can reduce the amount of calculation as compared with a single calculation for each of the multiple motor vehicles.

In a further embodiment of the disclosure, several alternative reference trajectories are received by the motor vehicle for the route to be traveled, and one of them is selected based on data on the surroundings and/or preference data from the vehicle occupant and/or model data concerning the motor vehicle. For example, the vehicle occupant specifies preference data describing whether the vehicle occupant desires a sporty or a comfortable ride. Depending on this, a comfortable reference trajectory or a comfortable reference trajectory can be selected from among the several alternative reference trajectories. The sporty reference trajectory, for example, involves higher cornering speeds, stronger braking maneuvers and stronger acceleration maneuvers than the comfortable reference trajectory. Alternatively or additionally, one of the several alternative reference trajectories can be selected based on the model data of the motor vehicle, for example, the power of the motor of the motor vehicle, a built-in chassis or built-in optional equipment. In particular, the comfortable or the sporty reference trajectory is selected on the basis of the model data. In another example, the multiple alternative reference trajectories may describe driving along multiple lanes of a travel route. For example, a respective reference trajectory is received by the motor vehicle for each lane of a multi-lane highway. One of the respective reference trajectories can then be selected on the basis of the data on the surroundings, for example the traffic volume on the different lanes and a position of the motor vehicle.

An embodiment of the disclosure provides that the reference trajectory is at least partially described by a sequence of coordinates. Thus, the reference trajectory is described by a multitude of positions. The coordinates or positions can be supplied at constant, predefined spaces or at different spaces from each other. For example, the coordinates or positions are at a distance of 5 cm, 10 cm, 20 cm, 30 cm, 50 cm or 100 cm from each other. Spaces between the positions or between the coordinates can be obtained by interpolation, for example, by spline formation. For example, the motor vehicle is guided autonomously by starting the sequence of coordinate specifications, in particular if no correction of the reference trajectory is necessary. The coordinates can additionally be supplemented by time information and/or speed information and/or acceleration information. In this way, the speed of the motor vehicle can be established for each point of the reference trajectory.

Alternatively or additionally, the reference trajectory can be described, at least in part, by information about landscape characteristics, which are detected on the basis of the data on the surroundings. Examples of landscape characteristics may be trees, bridges, piers, a guardrail or lane marking, a roundabout, an intersection and/or a footpath. Any objects or peculiarities of the environment of the motor vehicle can be used as landscape characteristics. Preferably, landscape characteristics are immutable objects or features. The reference trajectory can then be determined by relative coordinates to the landscape characteristic or to the landscape characteristics. As a result, a highly accurate GPS localization of the motor vehicle can be replaced or supplemented.

A further development provides that the reference trajectory that is used is one that is validated by a test driver. In particular, the central server device can validate the reference trajectory by means of the test driver. The test driver can be a driver of a special test vehicle, which drives in particular for purposes of testing the reference trajectory on the road. Alternatively, the test driver may be the driver of another motor vehicle traveling on the road and which is in contact with the server device and/or the motor vehicle. In particular, the driver chosen as a test driver is a person who has also traveled the route to be traveled by the motor vehicle a short time ago. In particular, the route to be traveled by the motor vehicle is driven by the test driver making use of the reference trajectory. In this way, a particularly high level of reliability of the reference trajectory can be ensured.

A second aspect of the disclosure relates to a motor vehicle having a control device for the autonomous guidance of a motor vehicle. The motor vehicle comprises a receiving device for receiving a reference trajectory. A continuous sequence of driving maneuvers, in particular steering maneuvers and/or acceleration maneuvers and/or braking maneuvers, can be determined or predetermined by the reference trajectory. For example, the continuous sequence of driving maneuvers or the continuous sequence of driving maneuvers can be determined or predetermined solely on the basis of the reference trajectory. For example, a vehicle device is designed to calculate the continuous sequence of driving maneuvers based on the reference trajectory. In particular, the reference trajectory can clearly determine or predetermine a course of movement of the motor vehicle. A detection device is designed to detect data on the surroundings of the motor vehicle. The motor vehicle may also include a validation device for checking the navigability of the reference trajectory based on the data on the surroundings and for generating a driving trajectory by correcting the reference trajectory based on the data on the surroundings. A control device is designed for the autonomous guidance of the motor vehicle along the driving trajectory. For example, the control device is designed to calculate a further continuous sequence of driving maneuvers based on the driving trajectory.

To solve the problem addressed by this disclosure, the receiving device is designed to receive a reference trajectory such as one that is described on the basis of track data, independently of the data on the surroundings, along which a roadway course extends along the route. By way of example, the receiving device for receiving the reference trajectory is an arithmetic unit. The arithmetic unit may be part of the motor vehicle or of a central server device. In particular, the arithmetic unit is designed to generate and/or calculate the reference trajectory independently of the data on the surroundings on the basis of the track data.

The disclosure also includes further developments of the motor vehicle according to the disclosure, which have features such as those previously described in connection with the further developments of the process according to the disclosure. For this reason, the corresponding further developments of the motor vehicle according to the disclosure are not described again here.

In the following an example of an embodiment of the disclosure is described, in which:

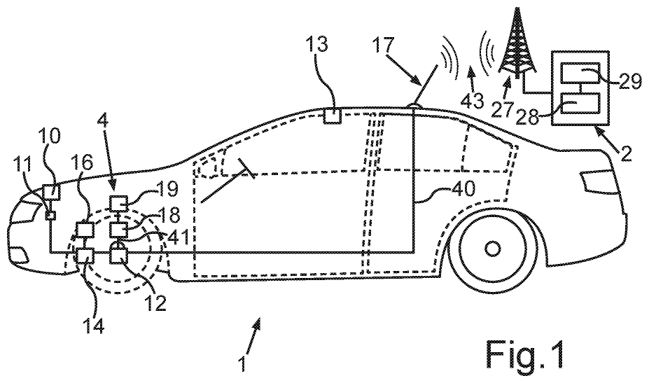

FIG. 1 shows a schematic view of a motor vehicle and a central server device.

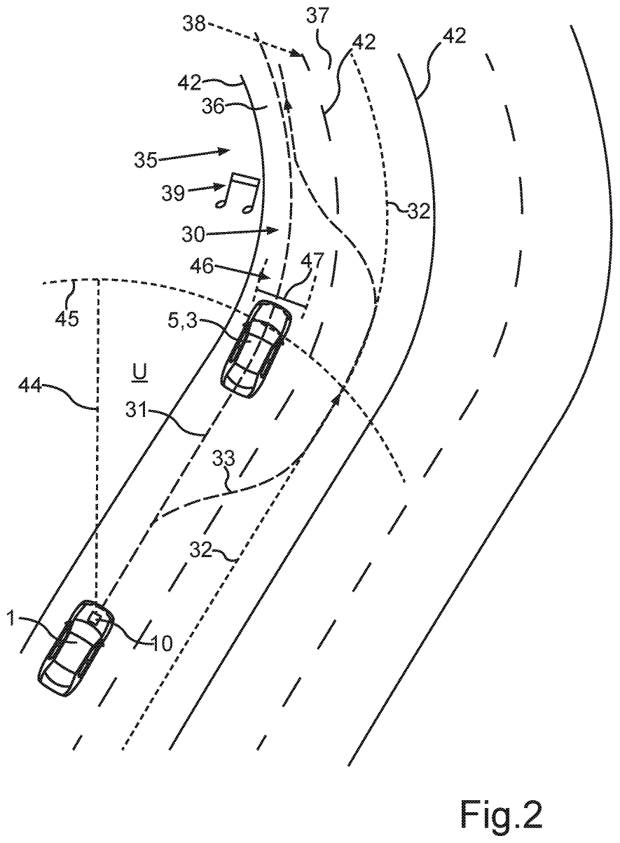

FIG. 2 shows an embodiment of the present method based on a schematic overview of a reference trajectory and a driving trajectory.

The example of the embodiment described below is a preferred embodiment of the disclosure. In this example of the embodiment, the described components of the embodiment constitute individual features of the disclosure that are to be considered independently of one another, which further develop the disclosure independently, and should thus be considered individually or in a combination other than that shown to be in the scope of the disclosure. In addition, features additional to those already described can also be added to the described embodiments.

Elements having the same function have been provided respectively with the same reference numerals in the drawings.

FIG. 1 shows a schematic side view of a motor vehicle 1 with a control device which is designed for the autonomous guidance of the motor vehicle 1. In the present case, the control device 4 comprises a receiving device 12, a detection device 10, a validation device 14 and a control device 16. The control device 4 may additionally or alternatively comprise an arithmetic unit 18 and/or a memory unit 19. In addition, the motor vehicle 1 in this case comprises an antenna device 17, which is designed to set up a wireless data connection 43 and is connected to the receiving device 12 by a data connection 40.

FIG. 1 also shows a central server device 2, which comprises an arithmetic unit 28 and a memory unit 29. For communication with the motor vehicle 1 and/or the antenna device 17 or the receiving device 12, the central server device 2 is, in the present case, connected to a transmission tower 27, in particular via a data line.

If something is subsequently written by the memory unit 19, 29 or the arithmetic unit 18, 28, then either one of the memory units 19, 29 or one of the arithmetic units 18, 28 or both of the memory units 19, 29 or both of the arithmetic units 18, 28 are meant.

The receiving device 12 receives a reference trajectory 31 for autonomous control of the motor vehicle 1, as shown in FIG. 2. A continuous sequence of driving maneuvers, in particular steering maneuvers and/or acceleration maneuvers and/or braking maneuvers, can be determined or predetermined by the reference trajectory 31. For example, the reference trajectory determines the continuous sequence of driving maneuvers. For example, the continuous sequence of driving maneuvers is calculated on the basis of the reference trajectory 31. In particular, a movement of the motor vehicle 1 can be unambiguously determined or predetermined by the reference trajectory 31. In particular, the reference trajectory 31 describes the travel of the motor vehicle 1 on a route 30 to be traveled by the motor vehicle 1. In particular, the travel of the motor vehicle 1 on the route 30 is substantially or fully determined by the reference trajectory 31. In particular, it is possible to control the motor vehicle 1 solely on the basis of the reference trajectory 31. In particular, the reference trajectory 31 may describe an optimal travel of the motor vehicle 1 along a road 35. The reference trajectory 31 may depend solely on a road course of the road 35. In particular, a traffic situation on the road 35, for example the presence of another motor vehicle 3, pedestrians, cyclists and/or mobile obstacles on the road 35, has no influence on the reference trajectory 31 or the composition of the reference trajectory 31.

In FIG. 2, the reference trajectory 31 can be configured on the basis of track data 38. The track data 38 may in particular describe the road course of the road 35 and/or the track course of one or more lanes 36, 37 of the road 35. Preferably, the track data 38 describe the track course and/or the road course with high accuracy of better than 1 cm, 2 cm, 5 cm, 10 cm, 20 cm, 30 cm, 50 cm. For example, the track course or the road course is described by the position and the orientation and the nature of the lane boundaries 42, for example crash barriers or lane markings. The track data 38 may be part of a map and/or provided by a map and/or extracted from a map. The map can be a highly accurate map, which describes or represents the road 35 or the lanes 36, 37 with the accuracy required for the track data 38, in particular as specified above.

Referring to FIG. 1 and FIG. 2, the reference trajectory 31 can, in particular, be received by the arithmetic unit 18 of the motor vehicle 1 and/or the arithmetic unit 28 of the central server device 2. In particular, the arithmetic unit 18 sends or transmits the reference trajectory 31 to the receiving device 12 by means of a data connection 41. The arithmetic unit 28 of the central server device 2 or the central server device 2 can send or transmit the reference trajectory 31 to the receiving device 12 of the motor vehicle. In particular, the reference trajectory 31 is transmitted by the central server device 2 to the receiving device 12 by means of the wireless data link 43, for example via Wi-Fi or the mobile phone network, by means of the transmission tower 27 and the antenna device 17.

The track data 38 or the map may be stored in the memory unit 19, 29. In particular, the arithmetic unit 18, 28 receives the track data 38 from the respective memory unit 19, 29. Alternatively or additionally, the arithmetic unit 18, 28 may receive the map from the memory unit 19, 29 and extract the track data 38 from the map. The track data 38 in the memory unit 19, 29, in particular the current day, current week, current month or current year, are updated daily, weekly, monthly, or annually. The track data 38 can particularly be updated in the memory unit 29 of the central server device 2, the update effort being particularly low in this case. For example, a two-hourly, hourly or even more frequent update is possible in this case. In a further embodiment of the present method, the track data 38 can be transferred and/or transmitted from the memory unit 29 of the central server device 2 to the memory unit 19 of the motor vehicle 1. In particular, the track data 38 stored in the memory unit 19 of the motor vehicle 1 may be updated by receiving updates or track data 38, particularly from the central server device 2. The track data 38 stored in the memory unit 19 of the motor vehicle 1 can either be updated at any time via the wireless data link 43, for example via the mobile phone network, or can only be updated if access to a stationary Internet connection, for example a DSL connection, via a wireless network, such as WLAN, exists.

The reference trajectory 31 can be calculated by the arithmetic unit 18, 28, in particular on the basis of the track data 38. In particular, the arithmetic unit 18, 19 is designed to generate or calculate the reference trajectory on the basis of the track data 38. The reference trajectory 31 can thus be formed, for example, within the motor vehicle 1 by the arithmetic unit 18 or outside the motor vehicle 1, i.e. by the arithmetic unit 28 in the server device 2. The reference trajectory 31, for example, can be generated so that the motor vehicle 1 is always located in the middle of the lane 36, 37 or in the middle between two lane boundaries 42. The reference trajectory 31 can always pre-specify a speed, for example, depending on a speed limit, a curve radius and/or a preference specification by a vehicle occupant. The preference specification can, for example, specify a comfortable or a sporty driving style. In the case of a sporty driving style, lateral forces acting on the vehicle occupants due to a rough ride can be limited to a first value and they can be limited to a second value in the case of a comfortable driving style. The first value is then, in particular, greater than the second value, while both the first value and the second value may be vehicle-dependent, in particular depending on model data of the motor vehicle 1. The lateral forces can, for example, be derived from a curve radius of a curve and the speed when driving on the curve. The model data relate in particular to the performance of the motor of the motor vehicle 1, the presence of special equipment, such as bucket seats and a sports suspension, the type of drive, such as rear-wheel drive, front-wheel drive or four-wheel drive, or the performance of the brakes. Alternatively or additionally, the performance of additional sensors of the motor vehicle 1, for example the detection device 10, may influence the calculation of the reference trajectory 31. For example, if the detection device 10 has a range of 100 m, the reference trajectory 31 can describe a higher travel speed of the motor vehicle 1 than if the detection device 10 only has a range of 50 m.

The detection device 10 of the motor vehicle 1 detects data on the surroundings 11, which relate to the surroundings U of the motor vehicle 1. The detection device 10 can, for example, be a camera, in particular a mono camera or stereo camera, a radar sensor, an ultrasound sensor, a Lidar sensor. In particular, several different and/or similar detection devices 10 may be provided. The detection device 10 may have a limited range 44 of, e.g., 25 m, 50 m, 100 m, 150 m or 200 m. The range 44 results in a detection horizon 45. The detection horizon 45 may be a circle around the motor vehicle 1, with the radius of the circle corresponding in particular to the range 44. The data on the surroundings 11, which are detected by the detection device 10, relate in particular to the surroundings U of the motor vehicle 1 within the detection horizon 45. For example, the location, position and/or orientation of lane markings and/or dynamic vehicle-external objects, for example another motor vehicle 3, cyclists and pedestrians, and/or stationary off-vehicle objects, for example lane boundaries 42, crash barriers and curbs, may be detected as part of the data on the surroundings 11. In general, the detection device 10 can detect a situation in the surroundings as well as the traffic situation as part of the data on the surroundings 11.

The navigability of the reference trajectory 31 can be checked on the basis of the data on the surroundings 11. For example, it is checked whether a vehicle-external object 5, in this case another motor vehicle 3, is located on the reference trajectory 31. This means in particular that the vehicle-external object 5 is located within a region 46 whose width 47 corresponds in particular to a width of the motor vehicle 1, particularly plus a safety clearance about the reference trajectory 31. In particular, the space 46 is the space which is swept out by the motor vehicle 1 when it follows the reference trajectory 31. The space 46 is merely hinted at in FIG. 2 for the sake of clarity. If the vehicle-external object 5 overlaps the space 46, the navigability of the reference trajectory 31 can be at least partially negated.

If the navigability of the reference trajectory 31 is negated at least partially or in terms of space, then a driving trajectory 33 can be generated on the basis of the data on the surroundings 11. The driving trajectory 33 is generated in particular by correcting the reference trajectory 31, in particular in the range for which the navigability of the reference trajectory 31 has been negated. FIG. 2 shows, by way of example, that the vehicle-external object 5 is overlapping the reference trajectory 31, which is why the navigability of the reference trajectory 31 is negated at least in that region. The reference trajectory 31 follows a first lane 36. In the present case, it is determined based on the data on the surroundings 11 that a second lane 37 is open. In particular, there are no other motor vehicles or no additional vehicles external to the vehicle on the other lane 37. For this reason, the vehicle-external object 5 can be bypassed and/or passed in accordance with the drawn driving trajectory 33. The driving trajectory 33 is in particular generated with minimal possible deviation from the reference trajectory 31. This means that the reference trajectory 31 is only corrected region by region on the basis of the data on the surroundings 11. In the regions in which the navigability of the reference trajectory 31 is detected, the driving trajectory 33 preferably corresponds at least essentially to the reference trajectory 31.

The course of the movement may be different due to the vehicle-external object 5, as described by the reference trajectory 31. In particular, the course of movement predetermined by the reference trajectory 31 can subsequently be modified on the basis of the data on the surroundings 11.

It can be provided that several alternative reference trajectories for the route 30 to be traveled are received by the motor vehicle 1 or the receiving device 12. According to FIG. 2, the reference trajectory 31 as well as an additional reference trajectory 32 are received as alternative reference trajectories by the motor vehicle 1 or by the receiving device 12. The several alternative reference trajectories can be generated or calculated by the arithmetic unit 18, 28, and/or transmitted or sent to the motor vehicle 1 or the receiving device 12. In the present case, the reference trajectory 31 describes the travel of the motor vehicle 1 in the first lane 36. The additional reference trajectory 32 describes a potential travel of the motor vehicle 1 in the second lane 37. In order to avoid the vehicle-external object or to correct the reference trajectory 31, it can be provided that the driving trajectory 33 is generated region by region by the additional reference trajectory 32. In the present case, the driving trajectory 33 initially follows the reference trajectory 31, then it proceeds to the other reference trajectory 32 and follows it region by region. Finally, the driving trajectory 33 approaches the reference trajectory 31 to again assume its course.

In general, one of the several alternative reference trajectories may be selected based on the data 11 on the surroundings. In the present case, the respective alternative reference trajectories are selected on the basis of the position of the vehicle-external object 5. Alternatively or additionally, several alternative reference trajectories can be selected based on the preference data of the vehicle occupant and/or the model data of the motor vehicle. For example, the several alternative reference trajectories may alternatively or additionally differ in the travel speed established for the motor vehicle 1, the maximum lateral forces in curves, the maximum acceleration values and/or the maximum deceleration values. A comfortable driving style or a sporty driving style can thus be selected based on the model data or the preference information.

The control unit 16 guides the motor vehicle 1 along the driving trajectory 33. The motor vehicle 1 thus performs an autonomous drive along the driving trajectory 33. In particular, the travel of the motor vehicle 1 is completely determined by the driving trajectory 33, which is why the control unit in particular only executes commands contained in the driving trajectory 33 or must comply with the conditions provided by the driving trajectory 33. The guidance comprises the longitudinal guidance and/or the transverse guidance of the motor vehicle 1. The control unit 16 can extract control signals from the driving trajectory 33 and/or send or transmit the control signals to respective actuators, for example the brakes, the engine control and/or the steering. The control signals can, for example, include brake signals and/or acceleration signals and/or steering signals.

The reference trajectory 31 may be generated by simulating a travel along the road 35. The simulation of the travel along the road 35 can be carried out, for example, on the basis of the track data 38. It is possible in particular to simulate many different trajectories with different parameters, such as the speed and the lateral acceleration and/or different routes. One trajectory from among the several trajectories can be selected as the reference trajectory 31 according to a predefined selection criterion. The predefined selection criterion comprises, for example, a maximum value for the lateral forces acting on the vehicle occupant, a minimum distance from the road boundaries 42 and/or a maximum value for the speed, which particularly corresponds to a speed limit. Alternatively or additionally, the predefined selection criterion may seek to maximize the curve speed of the motor vehicle 1, in particular while maintaining the aforementioned conditions.

The reference trajectory 31 can be calculated universally for several motor vehicles. In particular, after being sent to the motor vehicle 1 by the server device 2, the reference trajectory 31 is stored in the server device 2, for example in the memory unit 29. If the road 35 is subsequently traveled by another motor vehicle, the already calculated reference trajectory 31 can be transmitted to it. A new calculation effort for the reference trajectory 31 can thus be minimized. In particular, motor vehicles can be divided into vehicle classes, with one reference trajectory 31 or several alternative reference trajectories being stored for each vehicle class.

The reference trajectory 31 can be validated by a test driver. To test the road 35 or the reference trajectory 31, the test driver can be sent to the route 30 by the central server device 2. Alternatively or additionally, any motor vehicle driving the route 30 can serve as a test driver. In particular, the reference trajectory 31, after being driven by the test driver, is considered to have been tested. In this case, the reference trajectory 31 is particularly safe.

The reference trajectory 31 can be at least partially described by a sequence of coordinate specifications. In particular, the motor vehicle 1 or the receiving device 12 of the motor vehicle 1 receives the reference trajectory 31 as a sequence of coordinate specifications. For example, the coordinates refer to positions at respective intervals of 5 cm, 10 cm, 20 cm, 30 cm, 50 cm, 70 cm, 100 cm, 150 cm or 200 cm. Intermediate points which are not described by the coordinates can be determined by interpolation, for example by spline formation. In this case, the reference trajectory 31 may be described by a particularly small amount of data.

In order to follow the reference trajectory 31 precisely, it is necessary to determine the exact position of the motor vehicle 1 if the trajectory is described by coordinates. For this purpose, the motor vehicle 1 may comprise a high-precision localization module 13, in particular an RTK device. By means of the highly accurate localization module 13, a position determination of the motor vehicle 1 can take place with an accuracy of 1 cm, 2 cm, 5 cm, 10 cm, 20 cm or 30 cm. In order to enable an even more accurate position determination, the travel of the motor vehicle 1 can alternatively or additionally be evaluated. For example, the speed and steering angle of the motor vehicle 1 are evaluated in order to determine a change in position.

Alternatively or additionally, the reference trajectory 31 can be described at least partially by landmarks 39. Examples of landmarks 39 are traffic signs, lane boundaries 42, trees, traffic lights, intersections or roundabouts. The reference trajectory 31 can then be specified, at least partially, in in terms of coordinates relative to a respective landmark 39. The respective landmarks 39 can be detected by the detection device 10 of the motor vehicle as part of the data on the surroundings 11. It is thus possible to determine the position of the motor vehicle 1 relative to the landmarks 39.

According to FIG. 2, the route 30 to be traveled, for which the reference trajectory 31 is calculated, extends beyond the range of the detection device 10. In particular, the reference trajectory 31 is also received for a region that lies outside the detection horizon 45. The reference trajectory is preferably at least partially calculated by the arithmetic unit 18, 28 for the region outside the detection horizon 45 of the detection device 10. This makes it possible for the trajectory to be planned in a particularly foresighted way. If the landmark 39 is a town sign, the reference trajectory 31 or the additional reference trajectory 32 for example causes the motor vehicle 1 to start coasting early on. Such a forward-looking autonomous control of the motor vehicle 1 or planning of a trajectory is not possible on the basis of the data on the surroundings 11 alone.

Overall, the example shows how the disclosure allows for particularly anticipatory planning of the driving trajectory 33.

1.-10. (canceled)

11. A method for autonomous guidance of a motor vehicle, comprising:
receiving, by the motor vehicle, a reference trajectory, wherein the reference trajectory is generated on the basis of track data and the track data describes a track course of a road;
determining, using the reference trajectory, a continuous sequence of steering maneuvers, acceleration maneuvers or braking maneuvers for a route to be traveled by the motor vehicle, wherein the route runs along the track course of the road;
detecting, via a detection device of the motor vehicle, data on the surroundings, wherein the reference trajectory is independent of the data on the surroundings;
checking, on the basis of the data on the surroundings, navigability of the reference trajectory;
generating a driving trajectory by correcting the reference trajectory on the basis of the data on the surroundings; and
guiding the motor vehicle autonomously along the driving trajectory by a control device of the motor vehicle.

12. The method of claim 11, wherein the route to be traveled by the motor vehicle exceeds the range of the detection device.

13. The method of claim 11, further comprising:
prior to receiving the reference trajectory, calculating, by a central server device, the reference trajectory.

14. The method of claim 11, further comprising:
generating the reference trajectory by simulating a journey along the road.

15. The method of claim 11, further comprising:
calculating the reference trajectory universally for a plurality of motor vehicles.

16. The method of claim 11, further comprising:
receiving, by the motor vehicle, several alternative reference trajectories for the route to be traveled; and
selecting, based on the data on the surroundings, preference data from a vehicle occupant or model data of the motor vehicle, one of the several alternative reference trajectories for the route to be traveled.

17. The method of claim 11, further comprising:
describing the reference trajectory at least partially by a sequence of coordinate data.

18. The method of claim 11, further comprising:
detecting, on the basis of the data on the surroundings, information on landmarks; and
describing the reference trajectory at least partially by the information on landmarks.

19. The method of claim 11, further comprising:
validating the reference trajectory based on information from a test driver.

20. A motor vehicle with autonomous guidance, comprising:
a receiving device configured to receive a reference trajectory, wherein the reference trajectory is used to determine a continuous sequence of steering maneuvers, acceleration maneuvers or braking maneuvers for a route to be traveled by the motor vehicle, and the reference trajectory is generated based on track data, the track data describing a track course of a road and the route to be traveled by the motor vehicle extending along the track course of the road;
a detection device configured to detect data on the surroundings of the motor vehicle, wherein the reference trajectory is independent of the data on the surroundings;
a validation device configured to check the navigability of the reference trajectory on the basis of the data on the surroundings and generate a driving trajectory by correcting the reference trajectory based on the data on the surroundings; and
a control device configured to autonomously guide the motor vehicle along the driving trajectory.

21. The motor vehicle of claim 20, wherein the route to be traveled by the motor vehicle exceeds the range of the detection device.

22. The motor vehicle of claim 20, wherein the reference trajectory is calculated by central server device.

23. The motor vehicle of claim 20, wherein the reference trajectory is generated by simulating a journey along the road.

24. The motor vehicle of claim 20, wherein the reference trajectory is calculated universally for a plurality of motor vehicles.

25. The motor vehicle of claim 20, wherein the motor vehicle:
receives several alternative reference trajectories for the route to be traveled, and
selects, based on the data on the surroundings, preference data from a vehicle occupant or model data of the motor vehicle, one of the several alternative reference trajectories for the route to be traveled.

26. The motor vehicle of claim 20, wherein the reference trajectory is described at least partially by a sequence of coordinate data.

27. The motor vehicle of claim 20, wherein:
information on landmarks is detected on the basis of the data on the surroundings, and
the reference trajectory is described at least partially by the information on landmarks.

28. The motor vehicle of claim 20, wherein the reference trajectory is validated based on input from a test driver.
